(19) United States
(12) Patent Application Publication
(10) Pub. No.: US 2024/0395441 A1
(43) Pub. Date: Nov. 28, 2024

(54) A Superconducting Cable System

(71) Applicant: Supernode Ltd, Dublin (IE)

(72) Inventors: Marcos ACIN, Glasgow (GB); Eoin HODGE, Dublin (IE); Deon VOLSCHENK, Dublin (IE); Stephen DOYLE, Dublin (IE)

(21) Appl. No.: 18/363,784

(22) Filed: Aug. 2, 2023

(30) Foreign Application Priority Data
May 22, 2023 (EP) 23174677.7

(51) Int. Cl. H01B 12/16; H02G 15/34

(52) U.S. Cl. CPC H01B 12/16; H02G 15/34; H01B 12/14

(57) ABSTRACT

The present invention provides a superconducting cable system designed to facilitate long distance superconducting, the cable system including at least one inner cryostat containing a supply of cryogenic fluid and at least one superconductor extending longitudinally of the inner cryostat and in thermal communication with the cryogenic fluid, the inner cryostat comprising a liquid crystal polymer.

### CROSS-REFERENCE TO RELATED APPLICATION

This application claims priority to European App. No. EP23174677.7, filed on May 22, 2023, titled “A Superconducting Cable System,” which is incorporated in its entirety.

### FIELD OF THE INVENTION

The systems and methods disclosed herein relate to a superconducting cable system utilising at least one non-metallic cryostat. Some embodiments utilize at least one liquid crystal polymer cryostat.

### BACKGROUND OF THE INVENTION

The current state of the art in the design of high temperature superconductor (HTS) power cables includes the use of metallic alloy cryostats, typically of corrugated tubing, adopted from adjacent industrial uses such as liquid nitrogen gas (LNG) transfer solutions, to host HTS power cables and transmit pressurised cryogenic fluid to cool the HTS materials.

The metallic alloys are not efficient thermally and are not electrical insulators. This introduces challenges in the design and reliability of the cryostat system and HTS power cable. The conventional cross section of a HTS power cable system includes an inner corrugated tube arranged concentrically within the outer corrugated tube. The metallic alloy cryostats are designed to mechanically resist external mechanical loading and support a HTS power cable and cryogenic fluid within the inner corrugated tube. The corrugated profile tubing caters for the deficiencies in performance of metallic alloys including the Coefficient of Thermal Expansion (CTE) which results in the metallic alloy contracting both longitudinally and radially in dimension. These corrugations in the Inner corrugated tube result in significant pressure losses in the flow of cryogenic fluid, resulting in shorter longitudinal lengths of HTS power cable systems before re-pressurisation of the cryogenic fluid is needed.

Due to the metallic alloy characteristics, the HTS power cable includes independent dielectric insulation, typically of polypropylene laminated paper (PPLP) with liquid nitrogen (LN2), or equivalent, with a layer thickness proportional to the PPLP & LN2 dielectric strength and HTS power cable voltage. The dielectric may alternatively be added to the exterior of the corrugated cryostats, using conventional insulation such as cross-linked polyethylene (XLPE). The need for the HTS power cable to have independent dielectric insulation layers results in the HTS power cable having a larger outer diameter, thus inferring that in many embodiments the inner corrugated tube has a larger diameter to host the HTS power cable and sufficient cryogenic fluid to achieve a target mass flow rate to cool the HTS material.

In summary, the primary design issues and inefficiencies with state-of-the-art HTS power cable systems include:
Limited or single function layers within the cable system, for example, separate dielectric insulation on the conductor, and metallic cryostats to enclose a vacuum and cryogenic fluid;
Corrugated metallic cryostats resulting in heat ingress, additional turbulence generation in liquid cryogenic fluids and thus additional heat generation, higher pressure losses accumulated over shorter distances thus needing more pressurisation points on the HTS power cable system, and high friction factor heat generation in the cryogenic fluid;
Larger diameter cryostats required to host multi-layered HTS conductors resulting in greater radiative heat ingress;
High rates of thermal contraction and expansion with changes in temperature.
Complex manufacturability and associated costs;
Non-corrugated steel cryostats suffer from reliability and associated mobilisation and installation complexity.

There are currently no long-distance HTS power cables in operation. The longest is currently a project in development at 12 km which will use the conventional HTS power cable configuration described using corrugated steel cryostat. For short HTS power cable runs, extruded aluminium tubes or stainless-steel inner cryostat smooth-bore tubes can be used or lined corrugated cryostats. Smooth-bore stainless steel cryostats are the most common technology for terrestrial particle accelerators or LNG transfer pipes. These are typically installed with rolling or expansion devices to accommodate thermal contraction.

Alternatively, Invar (FeNi36) which is a nickel-iron alloy notable for its uniquely low CTE would allow for a smooth bore solution without having to accommodate thermal expansion upon cooling. Typical metallic alloys like stainless steel and aluminium suffer from larger coefficient of thermal expansion/contraction values resulting in requirements for multiple bellows-based expansion joints to offset the longitudinal contraction of the metallic tubes when filled with cryogenic fluid. These joints introduce failure points and thermal leak paths in the system thus undermining reliability.

The metallic alloys and carbon fibre composites conventionally employed are electrical and thermal conductors. Therefore, insulation layers are needed which increase the overall dimensions of the cryostat. Thermo-hydraulic performance and costs are negatively affected.

All smooth-bore metallic cryostats cannot be continuously manufactured and need to be welded in straight sections of around 12 meters. They cannot be reeled into a coil for transport. This increases the cost of manufacturing, transportation and deployment of such systems. A carbon fibre thermoset cryostat cannot be reeled due to its high stiffness.

Corrugated metallic cryostats generate additional turbulence and friction with the liquid cryogenic fluids thus additional heat generation and higher-pressure losses accumulated over shorter distances thus needing more pressurisation points on the HTS power cable system. Long distance SCS with corrugated IC are technically unfeasible.

Carbon fibre thermoset composites are known to develop cracks within the material when subjected to cryogenic environments. These cracks represent a permeability leak for the cryogenic liquid into the vacuum chamber potentially disrupting the SCS operation.

Thus, at the present time existing technologies are economically and technically unfeasible for long distance SCS deployment (i.e., 25 km lengths).

It is therefore an object of some embodiments to overcome the above-mentioned shortcomings of the prior art by providing an improved superconducting cable system capable of operating over long distances without significant performance degradation.

### SUMMARY OF THE INVENTION

In some embodiments, the systems and/or methods described herein (collectively referred to as the “system”) are directed to a superconducting cable system comprising at least one inner cryostat; a supply of cryogenic fluid within at least one lumen of the at least one inner cryostat; and at least one superconductor extending longitudinally of the at least one inner cryostat and in thermal communication with the cryogenic fluid. In some embodiments, the at least one inner cryostat comprises a liquid crystal polymer.

In some embodiments, the liquid crystal polymer comprises a thermotropic liquid crystal polymer.

In some embodiments, the liquid crystal polymer comprises an aromatic ester comprising aromatic dicarboxylic repeating units and/or aromatic hydroxycarboxylic repeating units and/or repeating units derived from aromatic diols, aromatic amides and/or non-aromatic monomers.

In some embodiments, the liquid crystal polymer comprises at least one filler.

In some embodiments, the at least one filler comprises a chopped filler. In some embodiments, the at least one filler comprises one or more of zirconium tungstate, glass fibres, PTFE fibres, carbon fibres, liquid crystal polymer fibres, carbon nanofibers, aramid nanofibers, nanotubes, boron nitride and graphene nanoparticles, as non-limiting examples.

In some embodiments, the one or more fillers comprise from 0.1% to 40% of the volume of the liquid crystal polymer.

In some embodiments, the liquid crystal polymer comprises a coefficient of thermal expansion of less than 10 e⁻⁶/C.

In some embodiments, the liquid crystal polymer comprises a permeability of less than 1×10⁻¹² cm³·cm/cm²/s/bar, as measured for nitrogen gas at room temperature.

In some embodiments, the liquid crystal polymer comprises a dielectric strength of between 0 kV/mm and 40 kV/mm.

In some embodiments, the liquid crystal polymer comprises a failure strain at break of between 1% and 20%.

In some embodiments, the liquid crystal polymer comprises a minimum service temperature of between 4° and 90° Kelvin.

In some embodiments, the liquid crystal polymer comprises a thermal conductivity of less than 0.5 W/mk.

In some embodiments, the liquid crystal polymer comprises a yield strength of greater than 25 MPa.

In some embodiments, the liquid crystal polymer comprises a stiffness of between 1 GPa and 100 GPa.

In some embodiments, the at least one superconductor is in retained within a lumen of the at least one inner cryostat.

In some embodiments, the cable system comprises a first inner cryostat and a second inner cryostat surrounding the first inner cryostat.

In some embodiments, the second inner cryostat comprises a liquid crystal polymer.

In some embodiments, the first and/or second inner cryostat comprises a smooth bore.

In some embodiments, the cable system comprises an outer cryostat enclosing the at least one inner cryostat.

In some embodiments, the cable system comprises a centraliser positioned between the outer cryostat and the at least one inner cryostat.

In some embodiments, the cable system comprises one or more layers of thermal and/or electrical insulation.

In some embodiments, one or more of the layers comprise thermal insulation comprising one or more of aerogel, nano-porous insulation, solid insulation, layered composite insulation, multilayer insulation, an insulation blanket and vacuum.

In some embodiments, the superconductor comprises a multiphase superconductor.

In some embodiments, the superconductor comprises multiple discrete superconducting elements.

In some embodiments, the superconducting elements are coaxially arranged and/or electrically insulated from at least adjacent superconducting elements.

In some embodiments, the superconducting elements are arranged in a circular or elliptical array coaxial with the at least one inner cryostat.

In some embodiments, the cryogenic fluid comprises liquid hydrogen, liquid nitrogen, liquid helium and/or other suitable cryogens.

### BRIEF DESCRIPTION OF THE DRAWINGS

The system will now be described with reference to the accompanying drawings, in which:

FIG. 1 illustrates a perspective view of a superconducting cable system according to some embodiments;

FIG. 2 illustrates a perspective view of a superconducting cable system according to some embodiments;

FIG. 3 illustrates a perspective view of a superconducting cable system according to some embodiments;

FIG. 4 illustrates a perspective view of a superconducting cable system according to some embodiments;

FIG. 5 illustrates a perspective view of a superconducting cable system according to some embodiments;

FIG. 6 illustrates a perspective view of a superconducting cable system according to some embodiments;

FIG. 7 illustrates a perspective view of a superconducting cable system according to some embodiments;

FIG. 8 illustrates a perspective view of a cryogen conduit according to some embodiments;

FIG. 9 illustrates a perspective view of a cryogen conduit according to some embodiments; and

FIG. 10 illustrates a perspective view of a cryogen conduit according to some embodiments.

### DETAILED DESCRIPTION OF THE DRAWINGS

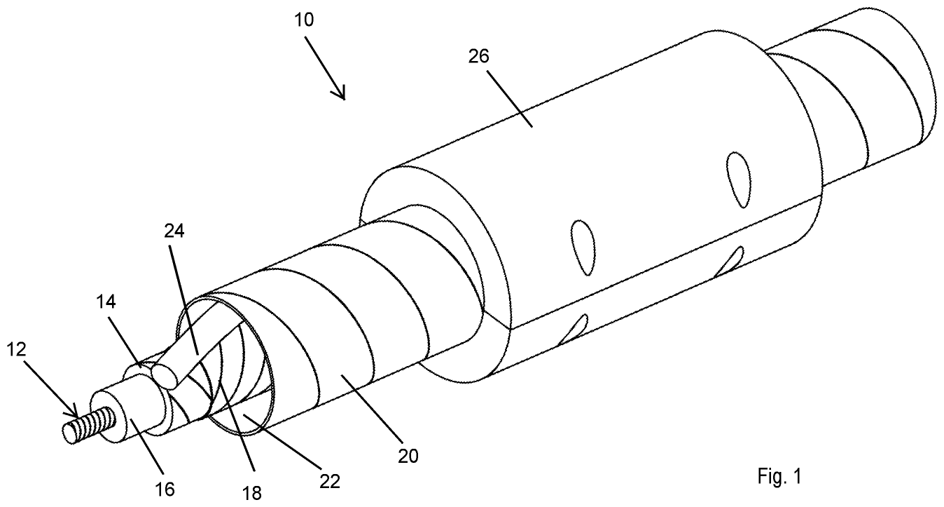

Referring now to FIG. 1 of the accompanying drawings there is illustrated a superconducting cable system, generally indicated as 10, for use is providing long distance superconducting capabilities while avoiding or reducing the issues associated with such applications of superconducting technology as detailed above according to some embodiments.

In some embodiments, the cable system 10 comprises a superconductor 12 which may be of a suitable material. In some embodiments, the superconductor 12 comprises a single component. In some embodiments, the superconductor 12 comprises multiple components. In some embodiments, the superconductor comprises an array and/or arrangement of superconducting ribbons or the like. In some embodiments, the superconductor 12 is configured to conduct single pole or multipole direct current (DC). In some embodiments, the superconductor 12 is configured to conduct a single phase or multiphase alternating current (AC). In some embodiments, the superconductor 12 is physically arranged on concentric axes (for example a tri-axis arrangement in a three-phase system) or adjacent axes (a tri-ad arrangement for a three-phase system). For AC systems, a so-called high temperature superconductor (HTS) or other conductive material or neutral conductor is included. In some embodiments, for AC or DC systems one or more forms of magnetic shielding layers are included, as exemplified in some embodiments described hereinafter. Some cable embodiments are configured for underground and/or undersea installation, while other cable embodiments are configured for installation above ground or sea.

In some embodiments, the superconductor 12 extends longitudinally within a central lumen of an inner cylindrical cryostat 14 which, in use, is at least partially filled with a cryogenic fluid (cryogen) 16. In some embodiments, non-limiting cryogenic fluids include liquid hydrogen, nitrogen, and helium, although it is envisaged that other liquid, gaseous or multiphase cryogens or combinations of cryogens may be utilised. In some embodiments, the superconductor 12 is in thermal communication with the cryogen 16 in order to maintain the requisite cryogenic temperature required for superconductivity. Although in the embodiment illustrated the superconductor 12 is in direct contact with the cryogen 16 in order to establish thermal communication, in some embodiments, indirect contact between the superconductor and cryogen i is configured to provide the thermal communication. In some embodiments, the operating temperature of the cryogen 16 varies depending on the operating requirements and/or conditions of the cable system 10 and/or additional or alternative parameters. In some embodiments, where liquid nitrogen is used as the cryogen 16, the operating temperature includes a range of around 67 K to 77 K at an operating pressure of between 0 bar and 25 bar. It should however be understood that these are exemplary parameters and lower or higher temperatures and/or pressures may be employed according to some embodiments. In some embodiments, the superconductor 12 is arranged eccentrically while still extending longitudinally relative to the overall length of the cable system 10. In some embodiments, the superconductor 12 is arranged to extend helically or the like, while still extending longitudinally relative to the overall length of the cable system 10.

In some embodiments, the cable system 10 comprises a layer of thermal insulation 18 surrounding the inner cryostat 14. In some embodiments, the cable system 10 comprises an outer cryostat 20 surrounding and/or enclosing the foregoing components. In some embodiments, a vacuum annulus 22 is positioned between the inner cryostat 14 and the outer cryostat 20 to provide additional thermal insulation. In some embodiments, the vacuum drawn in the vacuum annulus 22 reduces thermal convection in the cable system 10, and in some embodiments illustrated herein include a range of between 1 and 1000 Pa. In some embodiments, alternative vacuum levels are employed, for example a hard or soft vacuum. In some embodiments, a centralising element 24 is provided in the vacuum annulus 22 is configured to physically maintain the correct position of the inner cryostat 14 concentrically or otherwise with the outer cryostat 20. In some embodiments, the centralizing element 24 is configured to ensure a substantially uniform vacuum annulus 22. In some embodiments, the outer cryostat 20 provides environmental protection to the cable system 10, reduces thermal losses, avoids permeation of contaminants such as particulate matter and/or provides structural containment against the surrounding environment, which may as a non-limiting example be a body of water exerting pressure on the outer cryostat 20. In some embodiments, the outer cryostat 20 is includes a multilayer construction comprising a smooth bore steel pipe and/or corrugated steel jacket for environmental protection. In some embodiments, the outer cryostat 20 comprises a polymer pipe. In some embodiments, the polymer pipe includes one or more optional electrical insulation layers (not shown) and/or a permeation barrier layer. In some embodiments, a non-limiting example permeation barrier layer includes a metallic permeation barrier layer. In some embodiments, the centralising element 24 includes a suitable shape, configuration, and/or material. In some embodiments, a suitable shape includes helical shape configured to extend around the circumference of the annulus 22. In some embodiments, the cable system 10 includes an external ballast 26, for example where the cable system 10 is to be deployed underwater such as in subsea applications to ensure the cable system 10 sinks to the seabed.

In some embodiments, the function of the inner cryostat 14 is to contain the cryogen 16 and/or to enable thermal communication between superconductor 12 and the cryogen 16, which in the case of some embodiments such as FIG. 1 is achieved by locating the superconductor 12 within the lumen of the cryostat 14 wherein it is therefore in direct contact with the cryogen 16. In some embodiments, the cryostat 14 also is configured to serve one or more functions including providing structural integrity against the pressurised cryogen 16, acting as a dielectric insulator for the cable system 10 from the superconductor 12, acting as a thermal insulator to minimise heat ingress from the exterior, and acting as a permeability barrier between the cryogen 18 and the vacuum annulus 22.

In some embodiments, to facilitate design and transportation while minimising the cost of the cable system 10, the inner cryostat 14 includes a low coefficient of thermal expansion (CTE). In some embodiments, the low CTE material is configured to avoid or reduce the use of conventional bellows-based expansion joints, be capable of being spooled into reels, and/or be capable of being manufactured in long lengths. In some embodiments, long lengths include 1 km or longer. In some embodiments, long lengths conclude 10 km or longer.

In order to achieve said performance and manufacturing characteristics, in some embodiments, the inner cryostat 14 comprises a liquid crystal polymer (LCP). LCPs are quite different from conventional polymers. In some embodiments, the selected LCPs have one or more of the following properties that include low melt viscosity, fast cycle time in molding, very low mold shrinkage, excellent mechanical properties, solvent resistance, excellent barrier properties, low water absorption, low thermal expansion coefficient, excellent thermostability, low flammability, etc.

In some embodiments, compared to monomer liquid crystals, polymer liquid crystals can display similar behaviours, and be classified into thermotropic and lyotropic LCPs. In some embodiments, several classes of polymers including polyesters, polyethers and polyamides can exhibit liquid crystalline phases. According to different mesogen positions in the polymer, LCPs can be defined as main chain, side chain and combined LCPs, with more complex structures possible. Aromatic rings are the most common units used in LCPs.

In some embodiments, thermotropic main chain LCPs are a subgroup group of LCPs. In some embodiments, they consist of mesogenic groups incorporated into the backbone of the polymer chain, and when prepared without flexible spacers, are usually known as wholly aromatic thermotropic LCPs. Since they form LC phases when melted, the viscosity in the melt state is relatively low, improving processing according to some embodiments.

In some embodiments, polyesters are a subgroup group within this class of polymers. LCPs suitable according to some embodiments include structure containing one or more aromatic ester repeating units. In some embodiments, the one or more aromatic ester repeating units include a general molecular structure including a ring of substituted or unsubstituted 6-membered aryl group. In some embodiments, the one or more aromatic ester repeating units include a substituted or unsubstituted 6-membered aryl group fused to a substituted or unsubstituted 5- or 6-membered aryl group. In some embodiments, the one or more aromatic ester repeating units include a substituted or unsubstituted 6-membered aryl group linked to a substituted or unsubstituted 5- or 6-membered aryl group. In some embodiments, the molecular structure includes one or more side groups. Some non-limiting example aromatic ester repeating units according to some embodiments include aromatic dicarboxylic repeating units, aromatic hydroxycarboxylic repeating units, and/or combinations thereof. In some embodiments, the aromatic units include an amount of from 60 mol. % to 99.9 mol. %

In some embodiments, the aromatic dicarboxylic repeating units are derived from aromatic dicarboxylic acids. Suitable aromatic dicarboxylic acids include terephthalic acid, diphenyl ether-4,4′-dicarboxylic acid, bis(4-carboxyphenyl) ether, bis(4-carboxyphenyl) butane, bis(4-carboxyphenyl) ethane, bis(3-carboxyphenyl) ether, bis(3-carboxyphenyl) ethane isophthalic acid, 2,6-naphthalenedicarboxylic acid, 1,6-naphthalenedicarboxylic acid, 2,7-naphthalenedicarboxylic acid, 4,4′-dicarboxybiphenyl, according to some embodiments.

In some embodiments, the aromatic hydroxycarboxylic repeating units are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid and alkyl, alkoxy, aryl and halogen substituents, as non-limiting examples. Non-limiting aromatic hydroxycarboxylic acids include 4-hydroxybenzoic acid and 6-hydroxy-2-naphthoic acid according to some embodiments.

In some embodiments, repeating units may also be derived from aromatic diols and alkyl, alkoxy, aryl and halogen substituents. In some embodiments, aromatic diols include 4,4′-biphenol and hydroquinone. In some embodiments, repeating units are also employed, such as those derived from aromatic amides or aromatic amines. In some embodiments, one or more repeating units may be substituted with alkyl, alkoxy, aryl and halogen substituents.

In some embodiments, the LCP may comprise numerous other monomer based repeating units such as dicarboxylic acids, aliphatic or cycloaliphatic hydroxycarboxylic acids, amides, amines or diols.

In some embodiments, non-limiting examples of suitable commercially available LCPs include Vectra® as manufactured by Celanese Corporation, Laperos® as manufactured by Polyplastics Co. Ltd., Xydar® as manufactured by Solvay, Sumikausper™ as manufactured by Sumitomo Chemical, Siveras™ as manufactured by Toray Industries Inc., Ueno LCP® as manufactured by Ueno Fine Chemicals Industry, Ltd., and/or Vicryst® as manufactured by Kingfa. In some embodiments, optional fillers are added to the LCP in order to modify the mechanical, chemical, thermal and/or dielectric properties of the LCP. In some embodiments, non-limiting example fillers include zirconium tungstate (ZrW₂O₈), glass and/or polytetrafluoroethylene (PTFE) and/or carbon short fibres, boron nitride and graphene nanoplatelets. In some embodiments, the fillers comprise up to 20% by volume of the final LCP used in manufacturing the inner cryostat 14.

In some embodiments, the inner cryostat 14 is manufactured via an extrusion process into a smooth-bore pipe using the selected LCP and optional filler compounds to fulfil the inner cryostat 14 requirements and/or to improve the techno-economic feasibility of long-distance HTS power cables. In some embodiments, the provision of the smooth bore defining the inner lumen is configured to minimise drag on the cryogen 16 and therefore increase the operational length of the cable system 10. In some embodiments, manufacturing processes for the inner cryostat 14 include, but are not limited to, pultrusion, tape laying, tape or filamenting winding, fibre placement, waiving, braiding, injection moulding, thermoforming, compression moulding, roll moulding, and/or melt-blending.

Intermediate and/or inner or outer layers (not shown), which include metal or other composite layers in some embodiments, are coextruded with the inner cryostat 14 to improve its technical performance. In some embodiments, manufacturing methods that include these layers with the inner cryostat 14 include spraying, bonding with adhesives, welding, thermal bonding, tape laying, and/or wrapping.

In some embodiments, the use of LCP for the inner cryostat 14 allows the extrusion of a smooth inner bore with a controllable and preferential/neutral CTE in the longitudinal and radial directions. In some embodiments, this avoids the requirement for thermal expansion devices (not shown) and/or reduces the system pressure losses compared to conventional corrugated cryostats. In some embodiments, the LCP comprises a low thermal conductivity, high dielectric strength and/or low permeability which allows for a reduction in the number of insulation layers compared to state-of-the-art alternatives and/or a decrease in the overall dimensions of the cryostat 14 and/or the overall cable system 10.

In some embodiments, the LCP is manufactured through extrusion, as a long length or continuous and inexpensive manufacturing process, into a smooth-bore pipe. In some embodiments, the thermoplastic compound of the LCP includes a combination of properties that allows the LCP to be reeled for storage and transport thereby minimising costs.

In some embodiments, a non-limiting thermoplastic compound of the LCP includes fillers to have high strain failure at break (>3.5%), a strength of 200 MPa and/or a stiffness of 10 GPa. In some embodiments, a combination of these properties allows the inner cryostat 14 formed from said LCP to be reeled for storage and transport with a minimum bending radius (MBR) of 0.5-9 m depending on the diameter of the inner cryostat 14.

In general, the LCP with said modifying fillers according to some embodiments is selected to provide the inner cryostat 14 with the following non-limiting characteristics:

| | |
|---|---|
| Yield Strength [MPa] | Greater than 25 |
| Strength at break {Mpa] | Greater than 50 |
| Stiffness [GPa] | Between 1-100 |
| Failure Strain at break | Greater than 1% |
| Coefficient of Thermal Expansion | Less than \|10e⁻⁶/C.\| |
| Inner Cryostat [μm/mK] | |
| Thermal Conductivity [W/mk] | Less than 0.5 |
| Dielectric Strength [kV/mm] | Greater than 10 |
| Minimum service temperature [K] | 4 |
| Minimum in-service life-span [years] | 30 |
| Permeability Inner Cryostat (N2 at RT) | Less than 1 × 10⁻¹² |
| [cm³/cm · cm²/s/bar] | |
| Outgassing [TML %] | Less than 0.5 |

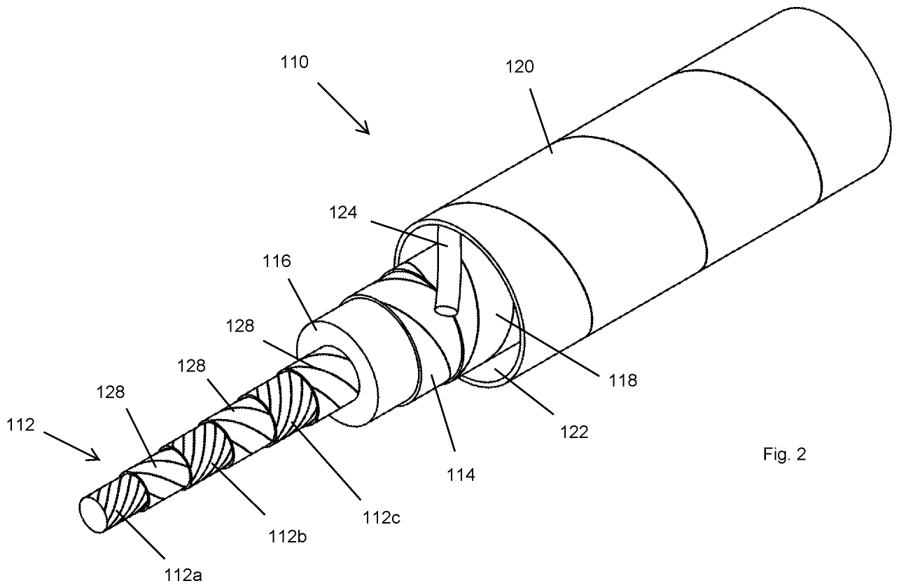

Referring now to FIG. 2, some embodiments of a superconducting cable system are illustrated and generally indicated as 110. In some embodiments, like components have been accorded like reference numerals and unless otherwise stated perform a like function.

In some embodiments, the cable system 110 comprises a superconductor 112 comprised of an inner superconducting element 112a, a first coaxial superconducting element 112b surrounding the inner element 112a and separated therefrom by a layer insulation 128, and/or a second coaxial superconducting element 112c surrounding the first coaxial superconducting element 112b and separated therefrom by a layer of insulation 128. In some embodiments, this arrangement is selected to conduct three phase AC current. It will of course be understood that a single pole or bi-axial bi-pole DC conductor (not shown) could be used as an alternative in some embodiments. In some embodiments, the superconductor 112 is located coaxially within the lumen of an inner cryostat 114 comprising a liquid crystal polymer as hereinbefore described, containing a cryogen 116 in which the superconductor 112 is therefore encapsulated such as to establish thermal communication therebetween. In some embodiments, a layer of thermal insulation 118 surrounds the inner cryostat 114, and includes a suitable form, for example comprising one or more of aerogel, nanoporous insulation, layered composite insulation, multilayer insulation or insulation blanket.

In some embodiments, an outer cryostat 120 surrounds the insulated inner cryostat 114, with a vacuum annulus 122 defined between the inner cryostat 114 and the outer cryostat 120 to provide additional thermal insulation. In some embodiments, a centralising element 124 is provided in the vacuum annulus 122 in order to physically maintain the corrected position of the inner cryostat 114 concentrically or otherwise with the outer cryostat 120 such as to ensure a uniform vacuum annulus region.

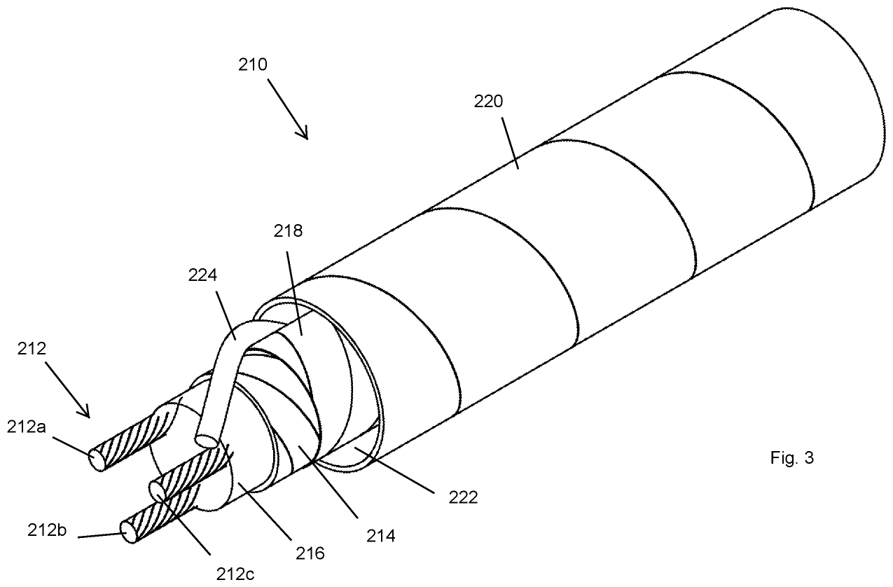

FIG. 3 illustrates a third embodiment of a superconducting cable system according to some embodiments, generally indicated as 210. In some embodiments, like components have been accorded like reference numerals and unless otherwise stated perform a like function.

In some embodiments, the cable system 210 comprises a superconductor 212 in a three-core tri-axis configuration comprising a first superconducting element 212a, a second superconducting element 212b and a third coaxial superconducting element 212c arranged in a circular array to facilitate three phase AC. In some embodiments, the superconductor 212 is located longitudinally within the lumen of an inner cryostat 214 comprising a liquid crystal polymer as hereinbefore described, containing a cryogen 216 surrounding the superconductor 212 to establish thermal communication therebetween. In some embodiments, a layer of thermal insulation 218 surrounds the inner cryostat 214, and includes a suitable form as hereinbefore described.

In some embodiments, an outer cryostat 220 surrounds the insulated inner cryostat 214, with a vacuum annulus 222 defined therebetween. In some embodiments, a centralising element 224 is provided in the vacuum annulus 222.

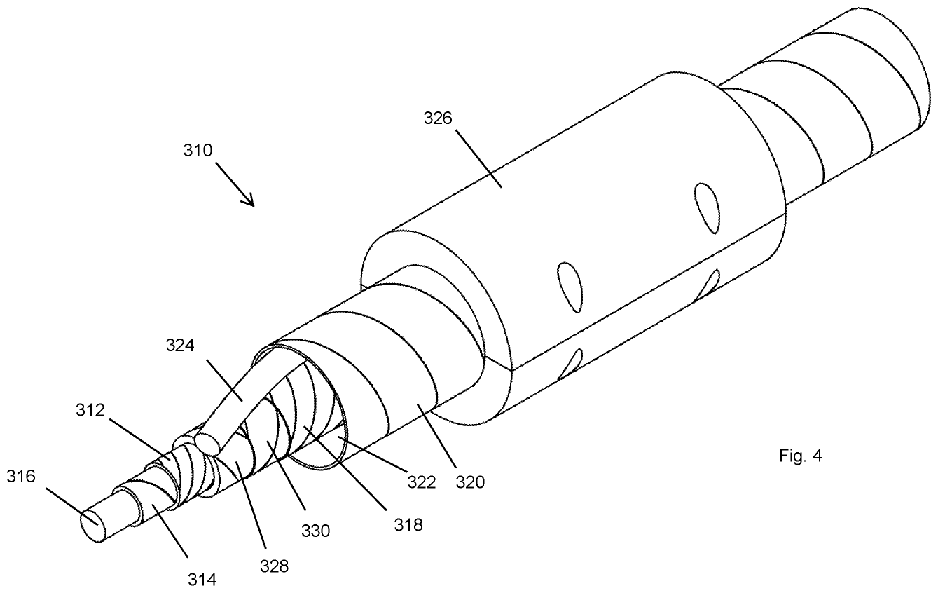

FIG. 4 illustrates a fourth embodiment of a superconducting cable system according to some embodiments, generally indicated as 310. In some embodiments, like components have been accorded like reference numerals and unless otherwise stated perform a like function.

In some embodiments, the cable system 310 comprises a superconductor 312 of tubular form and located longitudinally about an exterior surface of a first inner cryostat 314 in thermal communication therewith, the inner cryostat 314 comprising a liquid crystal polymer as hereinbefore described. In some embodiments, the inner cryostat 314 contains a cryogen 316 with which the superconductor 312 is in thermal communication via the inner cryostat 314 which provides structural integrity containing the pressurised cryogen 316 and acting as a permeability barrier.

In some embodiments, the cable system 310 additionally comprises a second inner cryostat 330 surrounding the first inner cryostat 314 comprising a liquid crystal polymer of suitable composition. In some embodiments, the second inner cryostat 330 is formed from a suitable alternative material, for example if the second inner cryostat 330 is not subject to internal pressurisation, which may occur purely in the first inner cryostat 314. In some embodiments, the second inner cryostat 330 include characteristics and dimensions appropriate to the lower structural and mechanical requirements, which may not provide sufficient dielectric strength in isolation, but may simply provide light mechanical protection for the superconductor. Accordingly, an additional electrical and/or mechanical layer 328 may be provided between the superconductor 312 and the second inner cryostat 330 in some embodiments.

In some embodiments, a layer of thermal insulation 318 outwardly surrounds the second inner cryostat 330 and may be a suitable form as hereinbefore described. In some embodiments, an outer cryostat 320 surrounds the insulated inner cryostats 314 and 330, with a vacuum annulus 322 defined therebetween. In some embodiments, a centralising element 324 is provided in the vacuum annulus 322. In some embodiments, ballast 326 is provided. In some embodiments, ballast 326 is provided about an exterior of the outer cryostat 320.

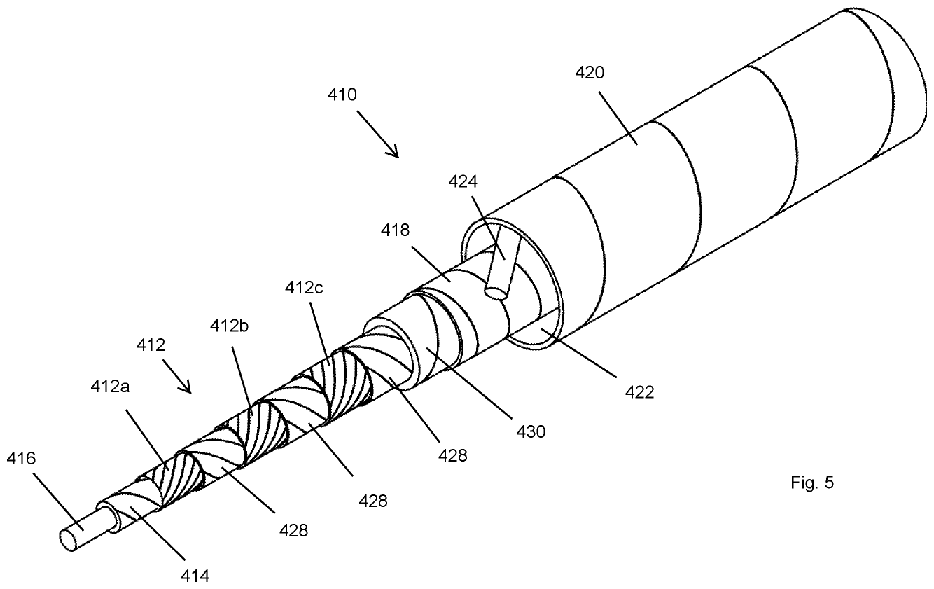

FIG. 5 illustrates a superconducting cable system according to some embodiments, generally indicated as 410. In some embodiments, like components have been accorded like reference numerals and unless otherwise stated perform a like function.

In some embodiments, the cable system 410 is similar to the cable system 310 shown in FIG. 4, but with a three phase co-axial superconductor 412 of tubular form and located longitudinally about an exterior surface of a first inner cryostat 414 in thermal communication therewith, the inner cryostat 414 comprising a liquid crystal polymer as hereinbefore described. In some embodiments, the superconductor 412 comprises one or more of an inner tubular superconducting element 412a, a first tubular and coaxial superconducting element 412b surrounding the inner element 412a and separated therefrom by a layer of insulation 428, and a second tubular coaxial superconducting element 412c surrounding the first coaxial superconducting element 412b and separated therefrom by a further layer of insulation 428. In some embodiments, this arrangement is selected to conduct three phase AC current.

In some embodiments, the inner cryostat 414 contains a cryogen 416 with which the superconductor 412 is in thermal communication via the inner cryostat 414. In some embodiments, the cable system 410 additionally comprises a second inner cryostat 430 surrounding the first inner cryostat 314 and again comprising a liquid crystal polymer of suitable composition or other suitable material. In some embodiments, a layer of thermal insulation 418 surrounds the second inner cryostat 430 and may be a suitable form. In some embodiments, an outer cryostat 420 surrounds the insulated inner cryostats 414 and 430, with a vacuum annulus 422 defined therebetween. In some embodiments, a centralising element 424 is provided in the vacuum annulus 422.

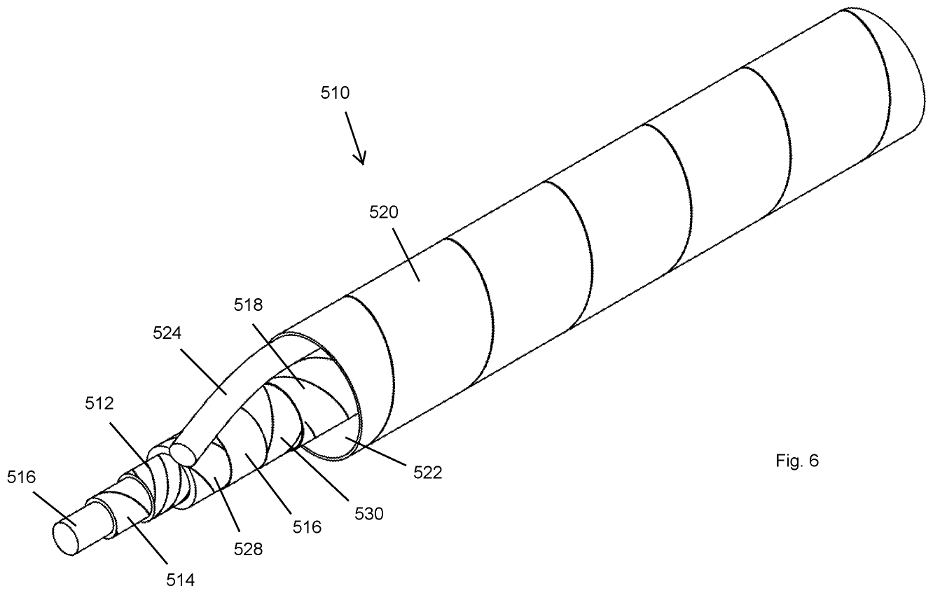

FIG. 6 illustrates a superconducting cable system according to some embodiments, generally indicated as 510. In some embodiments, like components have been accorded like reference numerals and unless otherwise stated perform a like function.

In some embodiments, the cable system 510 comprises a single-phase superconductor 512 and located longitudinally about an exterior surface of a first inner cryostat 514 in thermal communication therewith, the inner cryostat 514 comprising a liquid crystal polymer as hereinbefore described. In some embodiments, the single-phase superconductor 512 may be replaced with a multiphase superconductor as hereinbefore described in various previous embodiments. In some embodiments, the inner cryostat 514 includes a cryogen 516 with which the superconductor 512 is in thermal communication via the inner cryostat 514.

In some embodiments, the cable system 510 additionally comprises a second inner cryostat 530 surrounding the first inner cryostat 514 comprising a liquid crystal polymer of suitable composition and/or other material depending on the operational functionality of the second inner cryostat 530. In some embodiments, the second inner cryostat 530 defines a secondary lumen containing a second supply of the cryogen 516 to provide improved thermal performance. In some embodiments, this second supply comprises a different cryogen 516 to that contained within the first inner cryostat 514. In some embodiments, an electrical and/or mechanical layer 528 may be provided between the superconductor 512 and the second inner cryostat 530.

In some embodiments, a layer of thermal insulation 518 surrounds the second inner cryostat 530. In some embodiments, an outer cryostat 520 surrounds the insulated inner cryostats 514 and 530, with a vacuum annulus 522 defined therebetween and incorporating a centralising element 524.

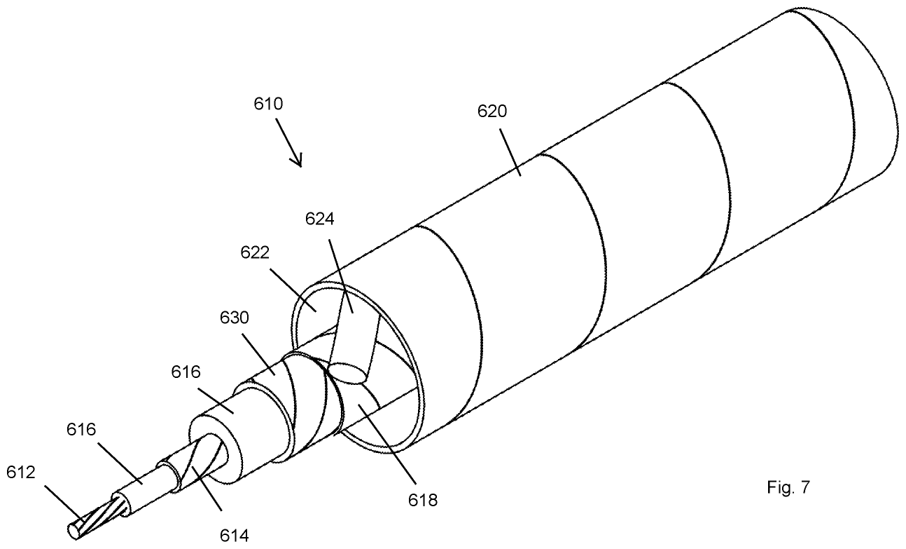

FIG. 7 illustrates a superconducting cable system according to some embodiments, generally indicated as 610. In some embodiments, like components have been accorded like reference numerals and unless otherwise stated perform a like function.

In some embodiments, the cable system 610 comprises a single-phase superconductor 612 of suitable form and extending longitudinally and/or coaxially within the lumen of a first inner cryostat 614 filled with a cryogen 616. In some embodiments, the superconductor 612 is in direct and/or thermal communication with the cryogen 616 in order to maintain the requisite cryogenic temperature required for superconductivity. In some embodiments, the single-phase superconductor 612 may be replaced with a multiphase superconductor as hereinbefore described.

In some embodiments, the cable system 610 additionally comprises a second inner cryostat 630 surrounding the first inner cryostat 614 and again comprising a liquid crystal polymer of suitable composition. In some embodiments, the second inner cryostat 630 defines a secondary lumen containing a second supply of the cryogen 616 to provide improved thermal performance. In some embodiments, the cryogen 616 is the same as the cryogen 616 contained within the first inner cryostat 614. In some embodiments, the cryogen 616 is different than the cryogen 616 contained within the first inner cryostat 614. In some embodiments, the cryogen 616 is maintained at a different temperature. In some embodiments, a layer of thermal insulation 618 surrounds the second inner cryostat 630. In some embodiments, an outer cryostat 620 surrounds the insulated inner cryostats 614 and 630, with a vacuum annulus 622 defined therebetween incorporating a centralising element 624.

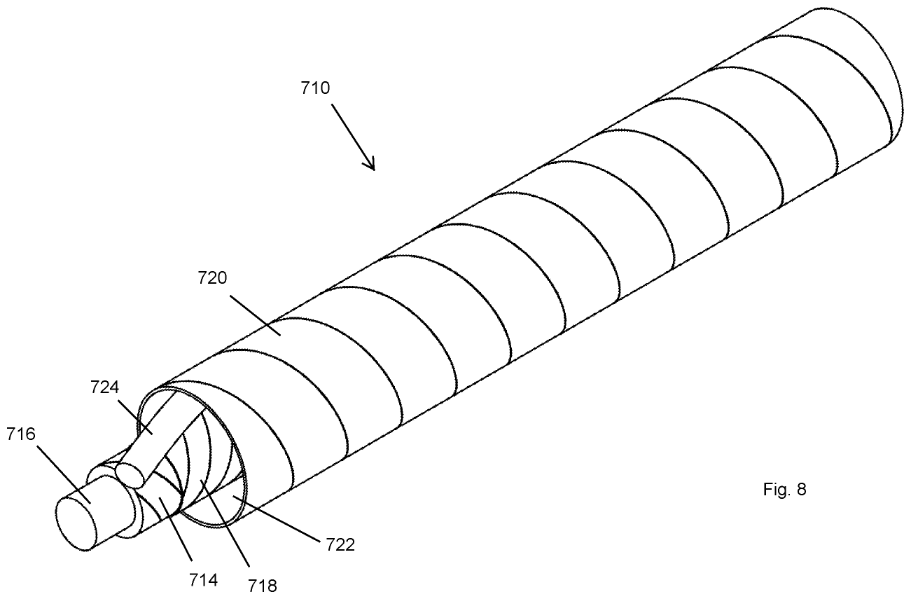

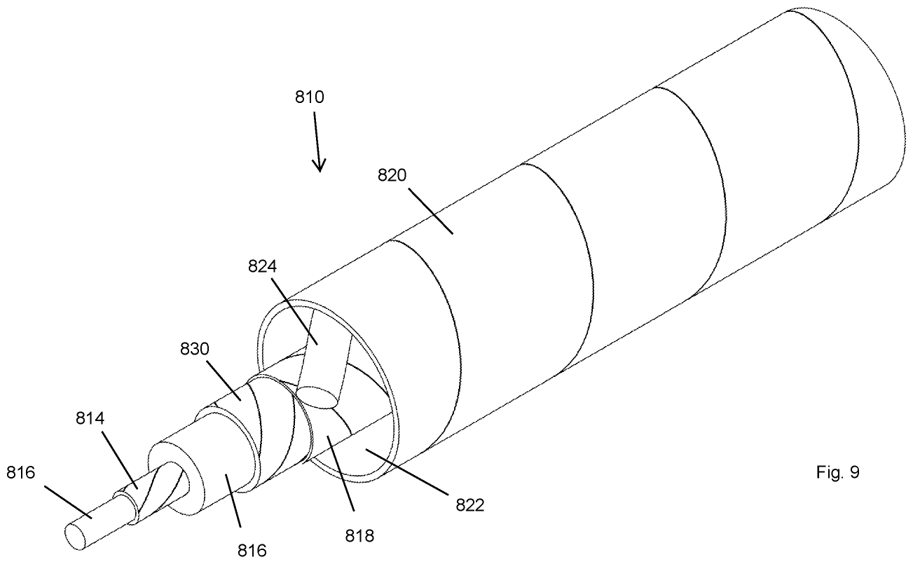

FIG. 8 illustrates a cryogen conduit which falls outside the scope of the system according to some embodiments. In some embodiments, the cryogen conduit, generally indicated as 710, utilises the general design and material properties of the superconducting cable system as hereinbefore described, but in the absence of a superconductor, and for the primary or hybrid purpose of transporting cryogenic fluid(s), for example but not limited to liquid nitrogen, liquid hydrogen, liquid helium, etc. In some embodiments, this transport includes one or more supply paths or loops, and optionally a return path or loop, for example as described hereinafter with reference to the embodiment of FIG. 9. In some embodiments, like components have been accorded like reference numerals and unless otherwise stated perform a like function.

In some embodiments, the cryogen conduit 710 comprises an inner cryostat 714 filled with a cryogen 716. In some embodiments, the inner cryostat 714 comprises a liquid crystal polymer as hereinbefore described. In some embodiments, a layer of thermal insulation 718 surrounds the inner cryostat 714, while an outer cryostat 720 surrounds the insulated inner cryostat 714, with a vacuum annulus 722 defined therebetween incorporating a centralising element 724.

FIG. 9 illustrates a cryogen conduit falling outside the scope of the system according to some embodiments, generally indicated as 810. In some embodiments, like components have been accorded like reference numerals and unless otherwise stated perform a like function.

In some embodiments, the cryogen conduit 810 comprises a first inner cryostat 814 comprising a liquid crystal polymer as hereinbefore described and/or includes a cryogen 816. In some embodiments, the cryogen conduit 810 comprises a second inner cryostat 830 surrounding the first inner cryostat 814 comprising a liquid crystal polymer of suitable composition. In some embodiments, the second inner cryostat 830 defines a secondary lumen comprising a second supply of the cryogen 816 to act as an initial cooling layer and thus provide improved thermal performance. In some embodiments, this second supply comprises a different cryogen 816 to that contained within the first inner cryostat 814. In some embodiments, the second inner cryostat 830 defines a cryogen return path. In some embodiments, a layer of thermal insulation 818 surrounds the second inner cryostat 830, while an outer cryostat 820 surrounds the insulated inner cryostats 814 and 830, with a vacuum annulus 822 defined therebetween incorporating a centralising element 824.

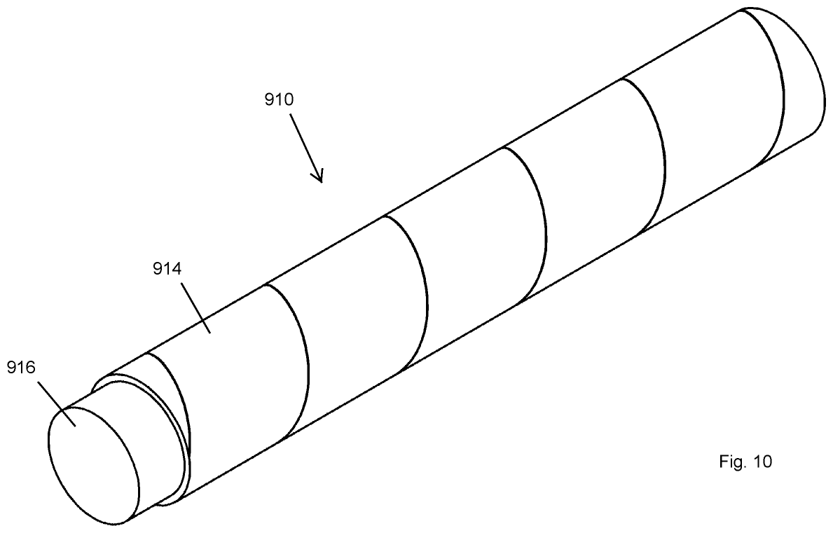

FIG. 10 illustrates a cryogen conduit system according to some embodiments, generally indicated as 910. In some embodiments, like components have been accorded like reference numerals and unless otherwise stated perform a like function.

In some embodiments, the cryogen conduit 910 comprises an inner cryostat 914 comprising a liquid crystal polymer as hereinbefore described, and/or comprises a cryogen 916. In some embodiments, the inner cryostat includes one or more layers (not shown) of insulation as hereinbefore described and is intended for use in the transport of liquid cryogens.

In some embodiments, it the superconducting cable system of the invention, as exemplified in the embodiments of FIGS. 1 to 7, can be used in a hybrid capacity to provide both superconductivity and/or to transport a liquid cryogen through one or more of the inner cryostats. In some embodiments, such transport includes a cryogen supply path defined by one inner cryostat and a cryogen return path defined by another inner cryostat, or two separate cryogen supply paths for separate cryogens. In some embodiments, this functionality is undertaken while the cable system is operational and providing superconducting electrical transmission, or while the superconducting functionality is inactive and therefore solely to transport one or more cryogens. In some embodiments, it is therefore to be understood that the materials, operating parameters, and functionality described above in relation to the superconducting cable system are integratable into some embodiments, such as those illustrated in FIGS. 8 to 10.

Thus, the use of at least one inner cryostat formed form a liquid crystal polymer within a superconducting cable system facilitates the realisation of long distance superconducting and cryogenic fluid transport, with optimal structural properties for the application and a cheaper life cycle than current and potential alternatives according to some embodiments.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use some embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

The term “cryogen” should not be construed as limiting, the superconducting cable system and cryogen conduit described herein being suitable for use in any low temperature application and thus the use of the term “cryogen” is not intended to convey use in only extreme low temperature 20 applications but rather in any cooled system.

Where the terms “cable” or “cable system” is used herein, it should be understood that this may encompass any cable, including but not limited to a suspended cable system, overhead cable system, buried cable system, submerged cable system. Therefore, where the term cable is used 25 herein it should be understood that this could be interchanged with the term “line” in the context of suspended cable applications.

It is understood that the phraseology and terminology used herein is for description and should not be regarded as limiting. The use of “including,” “comprising,” or “having” and variations thereof herein is meant to encompass the items listed thereafter and equivalents thereof as well as additional items.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

1. A superconducting cable system comprising at least one inner cryostat; a supply of cryogenic fluid within a lumen of the at least one inner cryostat; and at least one superconductor extending longitudinally of the at least one inner cryostat and in thermal communication with the cryogenic fluid; wherein the at least one inner cryostat comprises a liquid crystal polymer.

2. A superconducting cable system according to claim 1 in which the liquid crystal polymer comprises a thermotropic liquid crystal polymer.

3. A superconducting cable system according to claim 1 or 2 in which the liquid crystal polymer comprises an aromatic ester comprising aromatic dicarboxylic repeating units and/or aromatic hydroxycarboxylic repeating units and/or repeating units derived from aromatic diols, aromatic amides and/or non-aromatic monomers.

4. A superconducting cable system according to any preceding claim in which the liquid crystal polymer comprises at least one filler.

5. A superconducting cable system according to any preceding claim in which the at least one filler is selected from zirconium tungstate, chopped glass fibres, chopped PTFE fibres, chopped carbon fibres, chopped liquid crystal polymer fibres, carbon nanofibers, aramid nanofibers, nanotubes, boron nitride and graphene nanoparticles.

6. A superconducting cable system according to claim 5 in which the one or more fillers comprise from 0.1 to 40% of the volume of the liquid crystal polymer.

7. A superconducting cable system according to any preceding claim in which the liquid crystal polymer has a coefficient of thermal expansion of less than 10 e-6/C.

8. A superconducting cable system according to any preceding claim in which the liquid crystal polymer has a permeability of less than 1×10⁻¹² cm³·cm/cm²/s/bar.

9. A superconducting cable system according to any preceding claim in which the liquid crystal polymer has a dielectric strength of between 0 kV/mm and 40 kV/mm.

10. A superconducting cable system according to any preceding claim in which the liquid crystal polymer has a failure strain at break of between 1% and 20%.

11. A superconducting cable system according to any preceding claim in which the liquid crystal polymer has a minimum service temperature of between 4° and 90° Kelvin.

12. A superconducting cable system according to any preceding claim in which the liquid crystal polymer has a thermal conductivity of less than 0.5 W/mk.

13. A superconducting cable system according to any preceding claim in which the liquid crystal polymer has a yield strength of greater than 25 MPa.

14. A superconducting cable system according to any preceding claim in which the liquid crystal polymer has a stiffness of between 1 and 100 GPa.

15. A superconducting cable system according to any preceding claim in which the at least one superconductor is retained within a lumen of the at least one inner cryostat.

16. A superconducting cable system according to any preceding claim comprising a first inner cryostat and a second inner cryostat surrounding the first inner cryostat.

17. A superconducting cable system according to any preceding claim in which the second inner cryostat comprises a liquid crystal polymer.

18. A superconducting cable system according to any preceding claim in which the first and/or second inner cryostat comprise a smooth bore.

19. A superconducting cable system according to any preceding claim comprising an outer cryostat enclosing the at least one inner cryostat.

20. A cryogen conduit comprising at least one inner cryostat; a supply of cryogenic fluid within a lumen of the at least one inner cryostat; wherein the at least one inner cryostat comprises a liquid crystal polymer.
